(19) United States
(12) Patent Application Publication
(10) Pub. No.: US 2004/0200804 A1
(43) Pub. Date: Oct. 14, 2004

(54) Method of processing quartz member for plasma processing device, quartz member for plasma processing device, and plasma processing device having quartz member for plasma processing device mounted thereon

(76) Inventors: Norikazu Sugiyama, Yamanashi (JP); Hidehito Saegusa, Yamanashi (JP); Nobuyuki Okayama, Yamanashi (JP); Shunichi Iimuro, Yamanashi (JP); Kosuke Imafuku, Yamanashi (JP); Nobuyuki Nagayama, Yamanashi (JP); Kouji Mitsuhashi, Yamanashi (JP); Hiroyuki Nakayama, Yamanashi (JP); Yahui Huang, Yamanashi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/490,105

(22) PCT Filed: Sep. 12, 2002
(86) PCT No.: PCT/JP02/09311

(30) Foreign Application Priority Data
Sep. 25, 2001 (JP) 2001292251
Oct. 30, 2001 (JP) 2001332462

(51) Int. Cl. B44C 1/22

(52) U.S. Cl. 216/83; 65/31; 65/32.1; 65/61; 65/65; 65/62

(57) ABSTRACT

A member of processing a quartz member for a plasma processing device capable of suppressing the production of particles at the beginning of the use thereof and the production of chips thereafter, the quartz member for the plasma processing device, and the plasma processing device having the quartz member mounted thereon, the method comprising the steps of removing a large number of cracks 155 produced, after a diamond grinding, in the quartz member 151 for the plasma processing device used for a shield ring and a focus ring by performing a surface processing with abrasive grains of, for example, #320 to 400 in grain size, and performing the surface processing by using abrasive grains of smaller grain size to remove ruptured layers 163 while maintaining irregularities capable of adhering and holding deposit thereto.

### FIELD OF THE INVENTION

The present invention relates to a method for processing a quartz member for use in a plasma processing device; the quartz member for use in a plasma processing device, and a plasma processing device having the quartz member mounted therein; and, more particularly, to a method for processing a quartz member for use in a plasma processing device capable of preventing a formation of fragmental layers causing particles generated due to an exposure to a plasma, the quartz member for use in a plasma processing device, and a plasma processing device having the quartz member mounted therein.

### BACKGROUND OF THE INVENTION

As for an example of a plasma processing device for generating a plasma in a processing vessel and performing a process on an object to be processed, there is provided a plasma processing device including a processing vessel having an upper electrode and a lower electrode installed therein to face each other, wherein the plasma processing device processes an object to be processed by means of a plasma generated by introducing a process gas between the electrodes and applying a high frequency power thereto.

In such a plasma processing device, insulating members are. provided around peripheral portions of the upper electrode and the lower electrode and the plasma is confined in a region above the object to be processed in order to increase the efficiency in processing the object to be processed. As for the insulating members, quartz is generally used.

In case a quartz member is used inside the processing vessel, etched materials are inevitably deposited on a surface thereof. However, if the deposits are peeled off, a surface of the object to be processed can be contaminated thereby. For this reason, the quartz member is finished by, e.g., a surface processing using abrasive particles so that surface irregularities for adhering and holding the deposits thereto can be formed.

However, at the beginning of the use of the quartz member, the surface thereof is eroded, to thereby produce eroded quartz if it is exposed to the plasma. Then, thus eroded quartz becomes mist in the processing vessel, thereby causing generation of particles, e.g., to be adhered to a surface of the object to be processed and, thus, deteriorating an yield of the object to be processed.

Moreover, after a certain time period of the use thereof, deposits may be adhered to microcracks formed on the surface of the quartz member. In this case, when the deposits are exposed to an atmosphere or the like, they are expanded to peel off the surface layer of the quartz.

FIGS. 5A to 5D schematically show a variation of a surface of a quartz member on which a prior art surface processing is performed. Conventionally, a surface processing using abrasive particles of, e.g., # 360 in particle size, is performed on the quartz member after a diamond grinding in order to have deposits to be adhered and held thereto.

FIG. 5A is a conceptual diagram illustrating a cross sectional view of a quartz member before being used in a plasma processing device. As shown, it could be observed through an electron microscope that fragmental layers are formed on a surface 53 of a quartz member 51 due to microcracks 55 generated by a surface processing using abrasive particles.

When the quartz member 51 is used inside the plasma processing device, the fragmental layers formed on the surface of the quartz member 51 are eroded and become dust causing particles at the beginning of the use thereof. Furthermore, in case materials etched from the object to be processed are adhered as deposits 57, the deposits 57 may intrude into the microcracks 55, as illustrated in FIG. 5B. Thereafter, the deposits 57 are expanded when exposed to the atmosphere or the like, thereby developing cracks 59 due to the microcracks 55 as shown in FIG. 5C.

In addition, as illustrated in FIG. 5D, the deposits 57 may produce chips 61, thereby causing a surface of the quartz member 51 to be peeled off and contaminate a surface of the object to be processed, so that the yield can be deteriorated.

### SUMMARY OF THE INVENTION

The present invention has been made to overcome the above-mentioned drawbacks of a conventional method of processing a quartz member for use in a plasma processing device, the quartz member for use in a plasma processing device, and a plasma processing device having the quartz member mounted therein. Therefore, it is an object of the present invention to provide a new and improved method for processing a quartz member for use in a plasma processing device, the quartz member in a plasma processing device, and a plasma processing device having the quartz member mounted therein, capable of preventing fragments of the quartz member from being produced at the beginning of the use thereof and chips of the quartz member from being produced thereafter.

To achieve the aforementioned object, there is provided a method for surface-treating a quartz member, installed in a processing chamber for performing a processing on an object to be processed by a plasma excited therein, and having an exposed surface being exposed inside the processing chamber, wherein the exposed surface of the quartz member is processed by sequentially performing thereon a surface processing by using abrasive particles of a first particle diameter and a wet etching processing by using an acid.

After the surface processing by using the abrasive particles, it is preferable to further perform the wet etching by using an acid on the exposed surface of the quartz member. Further, the method for processing the quartz member for use in the plasma processing device may be carried out by performing the surface processing with abrasive particles and the wet etching by using an acid on the exposed surface of the quartz member after a processing by a fire polishing.

Besides, there are provided a quartz member for use in a plasma processing device on which a surface treatment is performed by using one of the above methods, and a plasma processing device having such a quartz member.

In accordance with said configuration, it is possible to provide a method for processing a quartz member for a plasma processing device, the quartz member for use in a plasma processing device, and a plasma processing device having the quartz member mounted therein, capable of suppressing the production of particles at the beginning of the use thereof and, at the same time, avoiding microcracks causing chips while maintaining fine irregularities capable of adhering and holding deposits thereto.

### BRIEF DESCRIPTION OF THE DRAWINGS

FIG. 1 shows a schematic cross sectional view of a plasma processing device in accordance with an embodiment of the present invention;

FIGS. 2A to 2D illustrate shapes of quartz members in accordance with the present invention;

FIGS. 3A to 3C depict cross sectional views schematically illustrating a variation of a surface of a quartz member on which a surface processing in accordance with a first embodiment is performed;

FIGS. 4A and 4B provide the number of particles generated from a quartz member, on which a surface processing is performed under various conditions, in a plasma processing device; and

FIGS. 5A to 5D describe cross sectional views schematically showing a variation of a surface of a quartz member on which a conventional surface processing is performed.

### DETAILED DESCRIPTION OF THE PREFERRED EMBODIMENTS

Hereinafter, preferred embodiments of a method for processing a quartz member for use in a plasma processing device, the quartz member for use in a plasma processing device, and a plasma processing device having the quartz member mounted therein in accordance with the present invention will be described in detail with reference to the accompanying drawings. Further, like reference numerals will be given to like parts having substantially same functions, and redundant description thereof will be omitted in the specification and the accompanying drawings.

(First Embodiment)

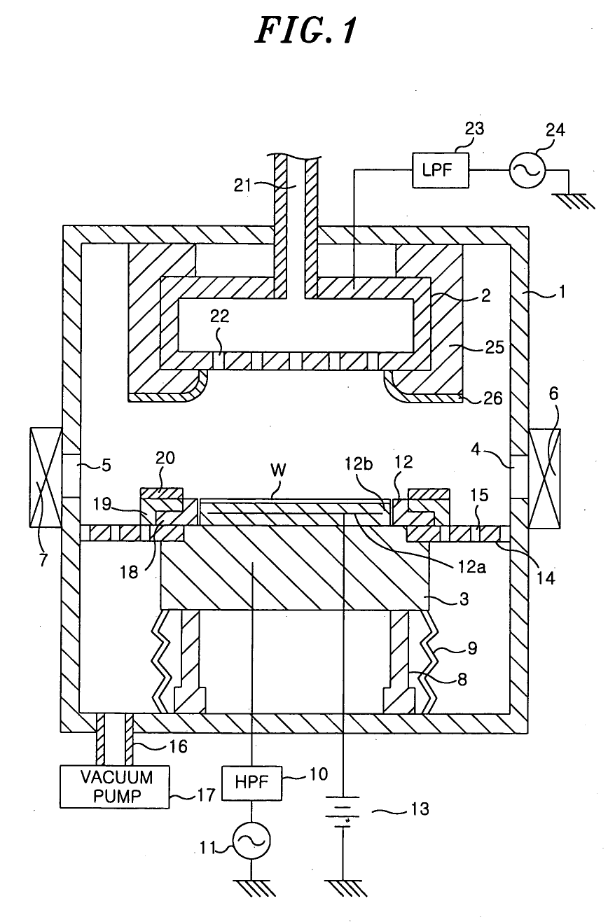

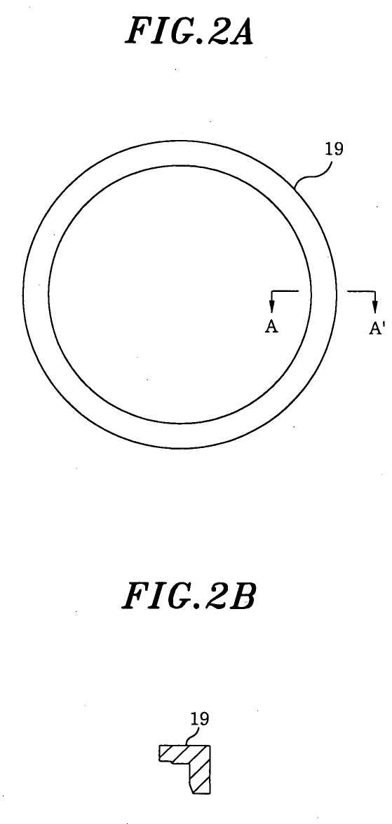

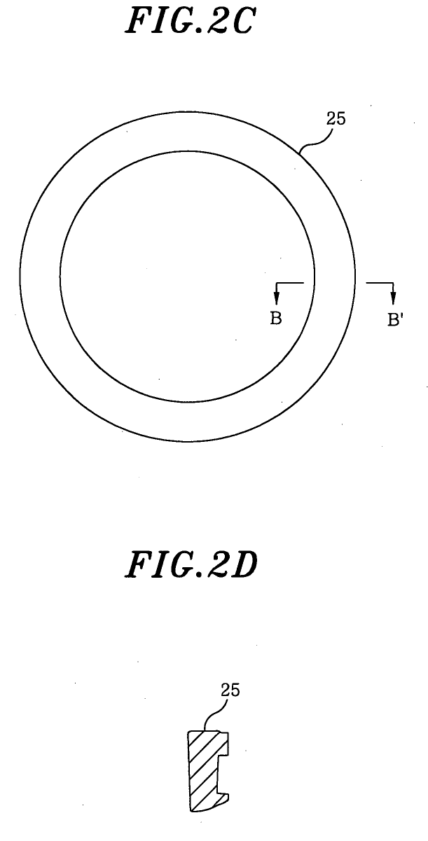

With reference to FIGS. 1 to 2D, a configuration of a plasma processing device in accordance with a embodiment of the present invention will now be described in detail. FIG. 1 shows a schematic cross sectional view of a plasma processing device in accordance with the embodiment of the present invention. FIGS. 2A to 2D illustrate shapes of quartz members in accordance with this embodiment, wherein FIG. 2A describes a top view of a focus ring 19; FIG. 2B depicts a cross sectional view taken along the line A-A′ in FIG. 2A; FIG. 2C provides a top view of a shield ring 25; and FIG. 2D presents a cross sectional view taken along line the B-B′ in FIG. 2C.

As illustrated in FIG. 1, the plasma processing device includes a cylindrical processing vessel 1 made of aluminum or the like, an upper electrode 2 and a lower electrode 3 facing each other in the processing vessel 1.

Installed on a sidewall of the processing vessel 1 are openings 4 and 5 for loading and unloading, e.g., a semiconductor wafer W, into and from the processing vessel 1. Gate valves 6 and 7 are provided at outer sides of the openings 4 and 5 to open and close the openings 4 and 5, respectively. Further, the gate valves 6 and 7 are able to air-tightly seal the processing vessel 1.

The lower electrode 3 is provided on an elevation mechanism 8 installed at a lower portion of the processing vessel 1. The elevation mechanism 8, which serves to move up and down the lower electrode 3, is formed by, for example, a hydraulic cylinder or a combination of a screw coupling device having a ball screw and a nut and a servo motor for rotating and driving the screw coupling device. Bellows 9 installed between the elevation mechanism 8 and an inner wall of the processing vessel 1 is used for preventing a plasma generated in the processing vessel 1 from leaking down below the lower electrode 3.

The lower electrode 3 is connected to a high pass filter 10 for preventing a high frequency component applied to the upper electrode 2 from intruding thereinto. The high pass filter 10 is connected to a high frequency power supply 11 supplying a voltage having, e.g., a frequency of 800 KHz.

An electrostatic chuck 12 is installed on a top surface of the lower electrode 3 in order to fix the semiconductor wafer W thereon. The electrostatic chuck 12 has a polyimide layer 12b and a sheet-shaped conductive electrode plate 12a embedded therein. The electrode plate 12a is electrically connected to a DC power supply 13 generating a coulomb force for temporarily maintaining the semiconductor wafer W.

A ring-shaped baffle plate 14 is installed between a periphery of the lower electrode 3 and the inner wall of the processing vessel 1. A multiplicity of exhaust holes 15 are formed at the baffle plate 14, so that an exhaust operation can be uniformly performed through the region around the periphery of the lower electrode 3. The exhaust line 16 is connected to a vacuum pump 17 to exhaust a process gas inside the processing vessel 1.

A focus ring 18 provided around the lower electrode 3 serves to diffuse a plasma on the semiconductor wafer W outwardly, thereby uniformly forming the plasma over the semiconductor wafer W to a circumferential edge portion thereof. The focus ring 18 of an annular shape is made of, e.g., silicon carbide (SiC).

Another focus ring 19 is installed on a peripheral portion of the focus ring 18 to have a different height and functions to confine the plasma in a region above the semiconductor wafer W, thereby increasing a density of the plasma. The focus ring 19 has an annular shape, as illustrated in FIGS. 2A to 2B, and is made of quartz.

An upper electrode 2 of a hollow structure is installed at an upper portion of the processing vessel 1 so as to face the lower electrode 3. Connected to the upper electrode 2 is a gas supply line 21 for supplying a predetermined process gas into the processing vessel 1. A number of gas diffusion holes 22 are formed at a lower portion of the upper electrode 2.

Connected to the upper electrode 2 is a low pass filter 23 serving to prevent a high frequency component applied to the lower electrode 3 from intruding thereinto. The lower pass filter 23 is connected to a high frequency power supply 24. The high frequency power supply 24 has a frequency of, e.g., 27.12 MHz, which is higher than that of the high frequency power supply 11.

A shield ring 25 made of quartz of an annular shape, as illustrated in FIGS. 2C to 2D, is installed around the upper electrode 2 and serves to confine the plasma in a region above the semiconductor wafer W. The shield ring 25 is fitted around a peripheral portion of the upper electrode 2.

In the following, an operation of the plasma processing device will be described in detail. First, the gate valves 6 and 7 are opened so that the semiconductor wafer W can be loaded from a load-lock chamber (not shown) and then mounted on the lower electrode 3. Thereafter, the gate valves 6 and 7 are closed.

A process gas introduced via the gas supply line 21 flows into the hollow upper electrode 2 and then is uniformly diffused through the gas diffusion holes 22 formed at the lower portion of the upper electrode 2.

In the meantime, a high frequency voltage of, e.g., 27.12 MHz, is applied from the high frequency power supply 24 to the upper electrode 2. After a predetermined period of time, e.g., less than or equal to 1 second, a high frequency voltage of, e.g., 800 KHz, is applied from the high frequency power supply 11 to the lower electrode 3, thereby generating a plasma between the two electrodes. Due to the generation of the plasma, the semiconductor wafer W is adsorptively held on the electrostatic chuck 12 firmly.

The plasma is confined between the shield ring 25 installed around the upper electrode 2 and the focus ring 19 disposed around the lower electrode 3 so that a density thereof increases. By using the high-density plasma, the semiconductor wafer W is processed.

At this time, the shield ring 25 and the focus ring 19 are exposed to the plasma, and deposits adhered to quartz or a quartz member are peeled off by erosion, thereby causing particles contaminating a surface of the semiconductor wafer W.

In order to solve such a problem, the quartz member such as the shield ring 25 and the focus ring 19 has been surface-treated after a diamond grinding, by a surface processing, e.g., a blast processing by using abrasive particles of, for example, #320 to 400 in particle size in order to enable deposits to be easily adhered and held thereto.

However, a large number of fine cracks(i.e., microcracks) are generated on the surface of the quartz member subjected to such surface treatment, which results in fragmental layers and thus generation of quartz dust at the beginning of the use thereof is could not be avoided.

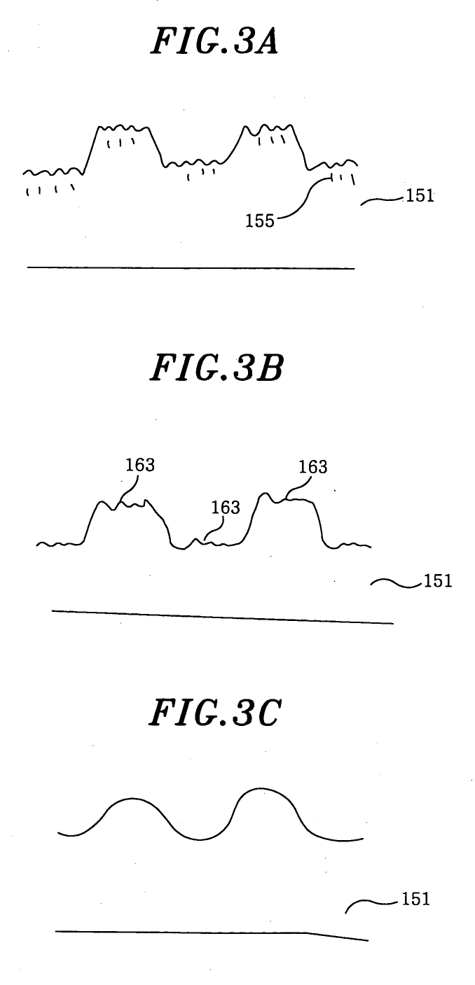

FIGS. 3A to 3C provide cross sectional views schematically illustrating a variation of a surface of a quartz member 151 treated by the surface processing method in accordance with a first embodiment. The quartz member 151 can be either to the shield ring 25 or the focus ring 19.

FIG. 3A indicates a surface obtained by performing a diamond grinding thereon. On this stage, a great number of cracks 155 are generated on the surface, so that deposits are hardly adhered and held thereto.

Referring to FIG. 3B, there is illustrated a surface obtained by performing a surface processing, e.g., a blast processing, with abrasive particles of, for example, #320 to 400 in particle size (a second particle diameter), which is same as in the conventional surface processing method. On this stage, the cracks 155 are removed but fundamental irregularities are maintained. Accordingly, it is possible to have deposits to be adhered and held thereto easily.

However, fragmental layers 163 are formed due to the microcracks remaining on the surface, and thus quartz easily becomes dust by the erosion resulting from the plasma at the beginning of the use of the quartz. Moreover, since the deposits may penetrate into the microcracks, chips causing the surface of the quartz to be peeled off are likely to be produced when the deposits are expanded after being exposed to the atmosphere.

Referring to FIG. 3C, there is illustrated a surface obtained by performing a surface processing (a sand polishing processing) with abrasive particles of, e.g., # 500 in particle size (a first particle diameter). In this case, the fragmental layers 163 can be removed while maintaining fundamental irregularities for having deposits to be adhered, thereby suppressing an initial production of initial particles and chips.

Subsequently, after the surface processing, e.g., the sand grinding, using abrasive particles of a fine particle diameter (e.g., # 500 in particle size), it is preferable to perform a wet etching by using an acid such as a hydrofluoric acid or the like. The wet etching is performed by immersing the quartz member 151 in, e.g., a 5 to 20 wt % hydrofluoric acid solution for 10 to 90 minutes and, preferably, in a 15 wt % hydrofluoric acid solution for 20 to 40 minutes. This makes the microcracks on the surface of the quartz member be reduced, thereby improving an yield in processing the semiconductor wafer W.

Additionally, the same effects as the aforementioned method can be obtained by sequentially performing a machining process such as the diamond grinding or the like; a surface processing, e.g., a blast or a sand polishing, by using abrasive particles of a fine particle diameter (about # 500 to 600 in particle size), while omitting a coarse surface processing by using abrasive particles of, e.g., # 320 to 400 in particle size (a second particle diameter) and a wet etching immersing the quartz member in a 5 to 20 wt % hydrofluoric acid solution for 10 to 90 minutes.

As described above, the surface of the quartz member can be processed by sequentially performing thereon the surface processing with abrasive particles of a fine particle diameter (a first particle diameter) and a wet etching by using an acid. This permits the fragmental layers on the surface to be removed while maintaining effects for having the deposits to be adhered and held thereto. Accordingly, it is possible to prevent a production of particles at the beginning of the use of the quartz member and a production of chips.

(Second Embodiment)

A method for processing a quartz member for use in a plasma processing device in accordance with a second embodiment is carried out by sequentially performing a diamond grinding; a fire polishing, i.e., a heat treatment using a burner or the like; a surface processing, e.g., a blast processing or a sand polishing processing, with fine abrasive particles of, e.g., about # 500 in particle size (a first particle diameter); and a wet etching by using an acid such as a hydrofluoric acid (HF) or the like. Further, when necessary, it may be preferable to perform, before the fire polishing process, a surface processing, e.g., a blast processing, by using abrasive particles of # 320 to 400 in particle size.

As mentioned in the first embodiment, in processing the surface of the quartz member for the plasma processing device, it is important to prevent microcracks from being generated while maintaining fundamental irregularities capable of having deposits to be adhered and held thereto.

To do so, surfaces of quartz members on which the surface processing had been performed by using five processing methods to be described below were observed with an electron microscope, to thereby check whether or not microcracks were generated thereon.

(method 1) a surface processing by using abrasive particles of # 360 in particle size (a conventional method).

(method 2) a fire polishing+a hydrofluoric acid processing.

(method 3) a fire polishing+a surface processing using abrasive particles of # 360 in particle size (a blast processing).

(method 4) a fire polishing+a surface processing using abrasive particles of # 500 in particle size (a blast processing).

(method 5) a fire polishing+a surface processing using abrasive particles of # 500 in particle size (a blast processing)+a hydrofluoric acid processing.

According to the observation results obtained by using the scanning electron microscope (SEM), microcracks were not generated in case of the methods 2 and 5. As for the quartz members on which the above two methods were performed, the number of particles generated when the quartz members were exposed to the plasma in the plasma processing device was examined.

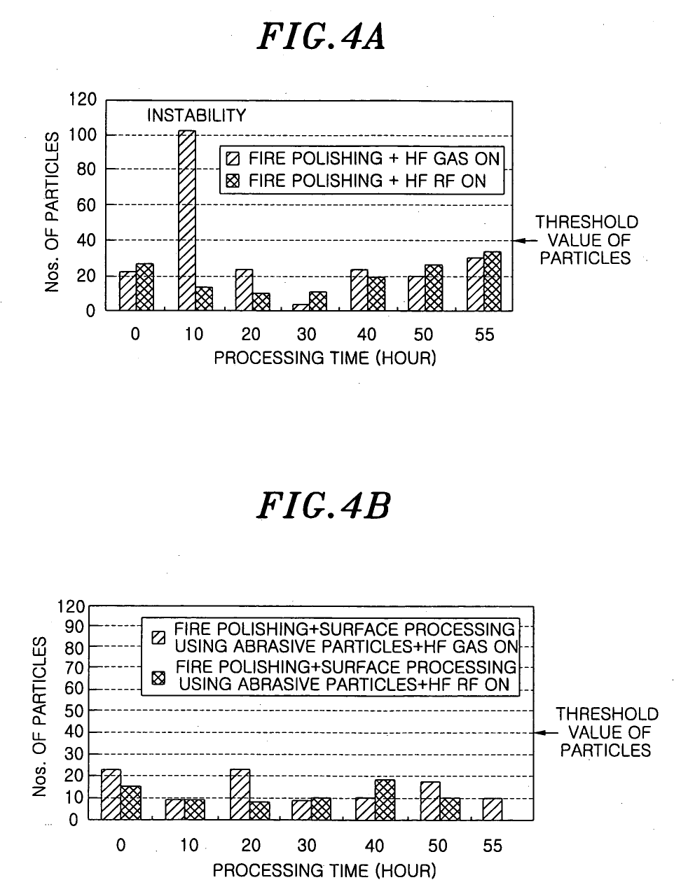

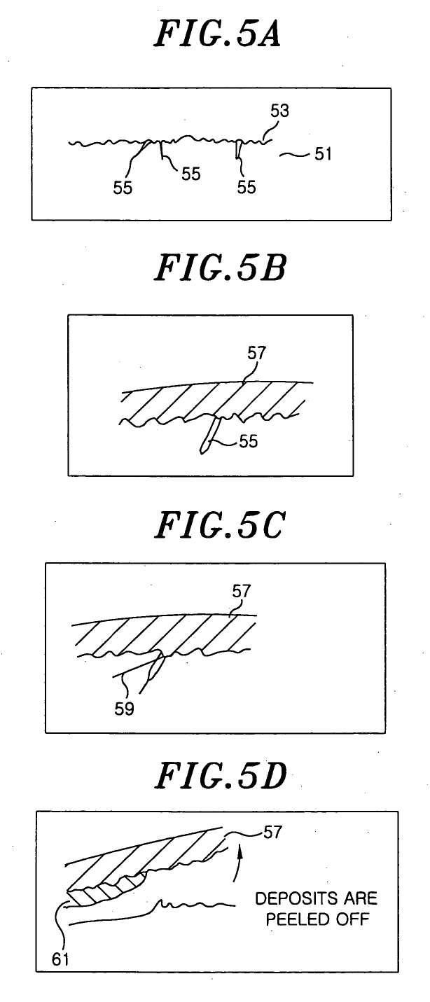

FIGS. 4A and 4B illustrate the numbers of generated particles of the quartz members which had been subjected to surface treatments by using the methods 2 and 5 and then treated in the plasma processing device. Processing conditions were as follows: process gas of C₄F₈/Co/Ar/O₂=10/50/200/5 sccm; a pressure of 45 mT; and an applied power of 1500 W. The X-axis indicates a processing time and the Y-axis represents the number of particles generated. The process in the plasma processing device was performed under two conditions of “gas on” and “RF on”, wherein in the “gas on” condition merely the process gas was flown and in the “FR on” condition the power for exciting the plasma was applied.

As shown in FIG. 4A, in case of the method 2, the number of particles generated during 10 hours of the processing time exceeded a threshold value of 40, which could be considered to hardly matter in practice. That is, the generation of the particles was not suppressed at the beginning of the use of the quartz member. In FIG. 4B, the number of particles generated during a processing time was less than or equal to the threshold value.

Therefore, among the above-described five processing methods, by performing the method having sequential steps of a fire polishing, a surface processing using abrasive particles of a fine particle diameter (e.g., # 500 in particle size) and a hydrofluoric acid processing for immersing the quartz member in, e.g., a 15 wt % hydrofluoric acid solution for 20 to 40 minutes, it is possible to avoid a production of particles at the beginning of the use thereof and a production of chips thereafter.

As described above, preferred embodiments of the method of processing the quartz member for use in a plasma processing device, the quartz member for use in a plasma processing device, and a plasma processing device having the quartz member mounted therein have been described with reference to the accompanying drawings. However, the present invention is not limited thereto. Therefore, it will be understood by those skilled in the art that various changes and modifications may be made without departing from the spirit and scope of the invention.

For example, a particle size of abrasive particles for use in the surface processing, a hydrofluoric concentration and a time of the hydrofluoric acid processing and the like are not limited to the above-mentioned examples. As long as the same effects are obtained, various changes thereof can be realized within the scope of the present invention.

Further, the surface processing method for the quartz member in accordance with the present invention is not limited to the focus ring and the shield ring and, further, can be applied to other members such as an inner wall of the plasma processing device and the like.

As described above, in accordance with the present invention, there is provided the method for processing a quartz member for use in the plasma processing device, the quartz member for use in the plasma processing device, and a plasma processing device having the quartz member mounted therein, thereby providing a satisfactory yield and a highly reliable processing while preventing a contamination of the semiconductor wafer by suppressing the production of the particles at the beginning of the use thereof and the production of chips thereafter.

Industrial Applicability

The present invention can be applied to a method of processing a quartz member for use in a plasma processing device, the quartz member for use in a plasma processing device, and a plasma processing device having the quartz member mounted thereon and, particularly, to a method of processing a quartz member for use in a plasma processing device capable of preventing a formation of fragmental layers causing the particles generated due to an exposure to a plasma, the quartz member for use in a plasma processing device, and a plasma processing device having the quartz member mounted therein.

What is claimed is:

1. A method for surface-treating a quartz member, installed in a processing chamber for performing a processing on an object to be processed by a plasma excited therein, and having an exposed surface being exposed inside the processing chamber,
wherein the exposed surface of the quartz member is processed by sequentially performing thereon a surface processing by using abrasive particles of a first particle diameter and a wet etching processing by using an acid.

2. The method of claim 1, wherein the exposed surface of the quartz member is surface-processed by using abrasive particles of a second particle diameter that is greater than the first particle diameter before the surface processing by using the abrasive particles of the first particle diameter.

3. A method for surface-treating a quartz member, installed in a processing chamber for performing a processing on an object to be processed by a plasma excited therein, and having an exposed surface being exposed inside the processing chamber,
wherein the exposed surface of the quartz member is processed by sequentially performing thereon a fire polishing, a surface processing by using abrasive particles and a wet etching processing by using an acid.

4. A quartz member, installed in a processing chamber for performing a processing on an object to be processed by a plasma excited therein, and having an exposed surface being exposed inside the processing chamber,
wherein the exposed surface of the quartz member is processed by sequentially performing thereon a surface processing by using abrasive particles of a first particle diameter and a wet etching by using an acid.

5. The quartz member of claim 4, wherein the exposed surface of the quartz member is surface-processed by using abrasive particles of a second particle diameter that is greater than the first particle diameter before the surface processing by using the abrasive particles of the first particle diameter.

6. A quartz member, installed in a processing chamber for performing a processing on an object to be processed by a plasma excited therein, and having an exposed surface being exposed inside the processing chamber,
wherein the exposed surface of the quartz member is processed by sequentially performing thereon a fire polishing, a surface processing by using abrasive particles and a wet etching processing by using an acid.

7. A plasma processing device comprising the quartz member of any one of claims 4 to 6.
